(19) United States
(12) Patent Application Publication
(10) Pub. No.: US 2017/0233176 A1
(43) Pub. Date: Aug. 17, 2017

(54) PACKAGED PRODUCT

(71) Applicant: The Procter & Gamble Company, Cincinnati, OH (US)

(72) Inventors: Robby Renilde Francois KEULEERS, Lippelo (BE); Katrien DE MALSCHE, Hamme (BE); Raf Gustaaf Alfons DEGEYTER, Herk-De-Stad (BE); Katy SAINT-IGNAN, Ixelles (BE)

(21) Appl. No.: 15/428,256

(22) Filed: Feb. 9, 2017

(30) Foreign Application Priority Data
Feb. 11, 2016 (EP) 16155345.8
Jan. 11, 2017 (EP) 17151079.5

(51) Int. Cl. B65D 85/804; B65D 25/20; B65D 83/00; C11D 11/00; C11D 17/04

(52) U.S. Cl. CPC B65D 85/804; C11D 11/0023; C11D 17/045; C11D 11/0017; C11D 17/043; B65D 83/00; B65D 25/205

(57) ABSTRACT

A packaged product having a container, wherein the container has a first compartment, a second compartment and an external opening wherein the container has at least two flexible water-soluble unit dose articles.

### FIELD OF THE INVENTION

The present invention relates to packaged products, particularly comprising a container and water-soluble unit dose articles

### BACKGROUND OF THE INVENTION

Water-soluble unit dose articles comprising cleaning compositions have become very popular with consumers. Such articles contain the cleaning composition which is only released once the article is contacted with water. This offers a convenient means for the consumer to dose the cleaning composition into the wash liquor without the need for scoops or other measuring means. Such unit dose articles are often packaged in tubs or bags, in which multiple unit dose articles are arranged randomly within the package.

However, an issue with such articles is that because they are water-soluble, they can rupture prematurely when they accidentally come into contact with water during storage. Such contact could include consumers accidentally touched an article with wet hands when retrieving a neighbouring article in a packaging tub or bag, or due to contact with moisture in the air during storage. Furthermore, the requirement to handle the unit dose article between the package and the washing operation causes a level of inconvenience to the consumer.

Related to this is the tendency for neighbouring pouches to stick to one another. This results in further requirements for the consumer to handle the neighbouring pouches in order to separate them before use. This in turn results in further opportunities for the neighbouring pouch to come into contact with moisture ahead of use.

Furthermore, moisture transfer can result in articles ‘clumping’ together meaning that said ‘clumps’ can get stuck in the opening of the package interfering with the wash process and/or the consumer has to touch the articles (including neighbouring articles) further in order to break the clumps apart.

Additionally, it is preferred to provide a system in which the instances of the consumer touching the article are reduced in order to minimise chemistry transfer from the surface of the article to the human hand.

Therefore, there is a need in the art for a means to dispense one unit dose article at a time, preferably directly into the washing machine, in which instances of consumer handling of the article is reduced. However, such means should be efficient, reliable and repeatable to use in a convenient manner. The time taken to complete the dosing operation should not be significantly longer than using executions currently on the market as this negatively affects the wash operation for the consumer as it reduces efficiency and convenience. Preferably, the time taken to dose should be less than the time taken with current on market executions.

It was surprisingly found that a container according to the present invention overcame this problem.

### SUMMARY OF THE INVENTION

The present invention discloses a packaged product comprising a container, wherein the container comprises a first compartment, a second compartment and an external opening, wherein the container comprises at least two flexible water-soluble unit dose articles, wherein the first compartment and the second compartment are connected via an internal opening, wherein the internal opening comprises a removable blocking means between the first and second compartments, wherein the blocking means is sufficient to prevent a water-soluble unit dose article from passing through the internal opening and wherein the blocking means has an upper surface and a lower surface wherein the upper surface faces the first compartment and the lower surface faces the second compartment; and wherein the external opening has a cross sectional area and wherein the opening connects to the second compartment and wherein the centre point of the cross-sectional area of the external opening is located at an angle of between 45° and 135°, preferably between 75° and 105°, most preferably 90° relative to the centre point of the lower surface of the blocking means.

The present invention is also the use of said packaged product.

### BRIEF DESCRIPTION OF THE DRAWINGS

FIGS. 1A, B, C and D disclose a packaged product according to the present invention

FIGS. 2A, 2B, 2C and 2D disclose unit dose articles according to the present invention.

FIGS. 3A, 3B and 3C disclose a container according to the present invention.

### DETAILED DESCRIPTION OF THE INVENTION

### Packaged Product

The present invention is to a packaged product comprising a container, wherein the container comprises a first compartment, a second compartment and an external opening.

The first compartment comprises at least two flexible water-soluble unit dose articles. The unit dose articles are described in more detail below.

The first compartment and the second compartment are connected via an internal opening, wherein the internal opening comprises a removable blocking means between the first and second compartments. The blocking means is sufficient to prevent a water-soluble unit dose article from passing through the internal opening. The container is described in more detail below.

Without wishing to be bound by theory, the unit dose articles are removed from the container via the external opening. This is achieved by the movement of the blocking means as is described below.

The packaged product can be sold ‘as is’, in other words the container is the item that the consumer picks up from the shelf. Alternatively, the packaged product could be housed as one unit of a multi-component consumer product. For example, more than one packaged product could be housed within an outer package and the multiple packaged products sold together in a single purchase.

The packaged product may be sold as separate components. For example, the packaged product may be sold as a dispensing device, and a separate refill component. The refill component may connect with the dispensing apparatus to form the packaged product. Alternatively, the consumer may manually refill the packaged product with unit dose articles where the unit dose articles used to refill the packaged product are sold in a separate container. Those skilled in the art would recognise suitable refill components and separate containers.

The packaged product may comprise aesthetic elements, for example shrink sleeves or labels attached to the container. Alternatively, the container may be coloured or printed with aesthetic elements or informative print such as instructions.

### Container

The container comprises a first compartment and a second compartment and an external opening.

The container may be of any suitable shape. The container may have an overall straight shape, e.g. with straight sides, or may have a curved shape or may comprise both straight and curved elements. The container may have a cubic shape, a cylindrical shape, a rectangular shape. Preferably the container has a straight shape, i.e. a shape comprising straight sides.

The container may be made from any suitable material. The container may be made from metallic materials, Aluminium, plastic materials, cardboard materials, laminates, cellulose pulp materials or a mixture thereof. The container may be made from a plastic material, preferably a polyolefin material. The container may be made from polypropylene, polystyrene, polyethylene, polyethylene terephthalate, PVC or a mixture thereof or more durable engineering plastics like Acrylonitrile Butadiene Styrene (ABS), Polycarbonates, Polyamides and the like The material used to make the container may comprise other ingredients, such as colorants, preservatives, plasticisers, UV stabilizers, Oxygen, perfume and moisture barriers recycled materials and the like.

The container may be made used any suitable process. Suitable processes include but are not limited to thermoforming, injection molding, injection stretch blow molding, extrusion blow molding, tube forming from a flat laminate with a welding step, extruded tube forming. The container may be opaque, transparent or translucent. Preferably, the container is opaque. The container may comprise a region, such as a strip that allows the consumer to view the internal compartment of the container and ascertain how many unit dose article are present.

Preferably the container has a recognisable base such that when at rest the base is located on the underside of the container as it rests on a surface. By virtue, the container will also have a top and sides.

The container comprises a first compartment and a second compartment. The compartments are located internally in the container. The container comprises walls having an inner surface and an outer surface. The outer surface of the walls comprise the external side of the packaged article. The inner walls define the first and second compartments. The container may comprise more than a first and a second compartment.

The first and second compartments may have any suitable shape. The shape of the compartments may be substantially the same shape as the container or may differ from the shape of the container. The compartments may be the same shape as each other or may be different. The internal compartments may have any suitable shape. Those skilled in the art will recognise suitable shapes able to accommodate the unit dose articles. The internal compartments may be circular, square, rectangular, triangular or oval in shape, or a mixture thereof. The first compartment is of a size sufficient for at least two water-soluble unit dose articles to fit.

The second compartment is of sufficient size for one unit dose article to fit.

The first compartment acts as a ‘bulk storage’ area for unit dose articles ahead of them being dispensed out of the container. The second compartment acts as an intermediate ‘temporary holding’ area for a single unit dose article during the dispensing operation which will be explained in more detail below.

The container comprises at least two flexible water-soluble unit dose articles.

The unit dose articles may be arranged in a random order in the first compartment or in a linear order. The unit dose articles may be positioned side-by-side to form a single row of unit dose articles within the container. Preferably, the unit dose articles are arranged in a vertical single row with respect to the container when the container is at rest and placed on its base on a horizontal surface. Without wishing to be bound by theory, by placing in a single row, there is reduced contact between neighbouring unit dose articles. This reduces the risk of contamination of multiple neighbours by e.g. water from the hands of consumer retrieving a unit dose article or from contamination of leaking unit dose articles. Also, since they are arranging in a single row, there is reduced risk of neighbouring unit dose article ‘clumping’ together and causing blockage of the internal opening. Without wishing to be bound by theory, if the unit dose articles are arranged in a row the contact point between adjacent unit dose articles is well defined. Clumping can be reduced via a sliding means to pull the unit dose articles apart again.

The single row arrangement also has the added benefit of maximising space during storage of the packaged product. Traditional tubs and bags tend to have a large footprint which is inconvenient to the consumer during storage of the product. By ensuring the unit dose articles are arranged in a single row, the footprint of the container may be reduced.

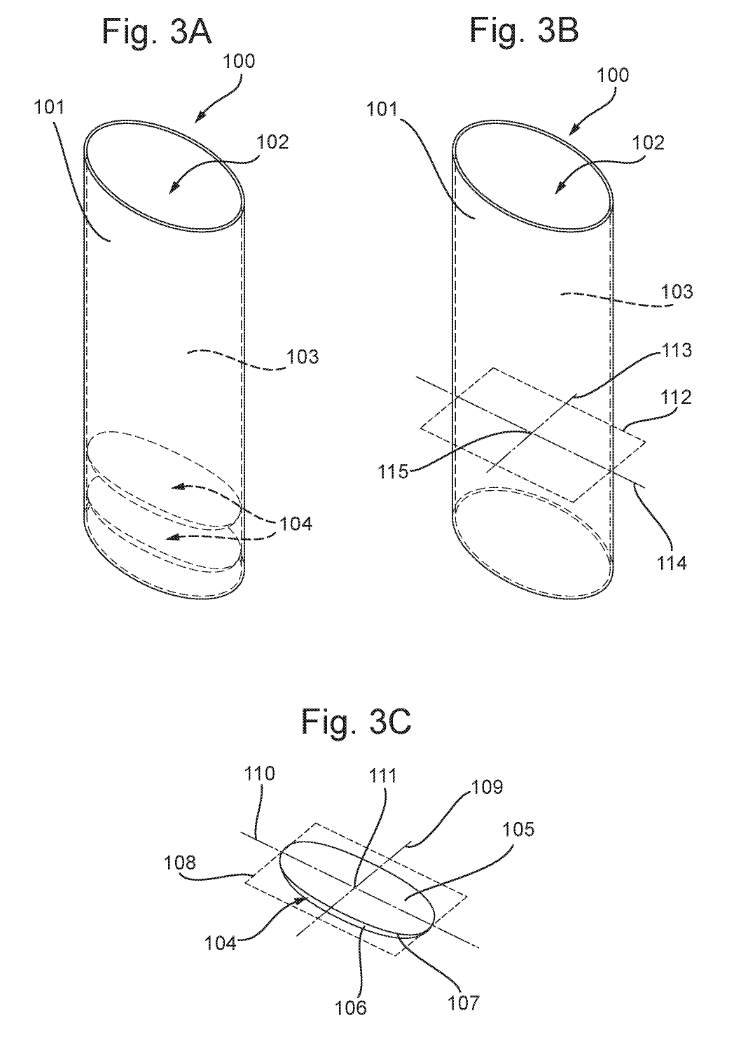

As can be seen in FIG. 3, preferably the packaged product 100 comprises a container 101 wherein the container 101 comprises an opening 102 and an internal compartment 103, and at least two flexible water-soluble unit dose articles 104 held within the internal compartment 103 of the container 101. The unit dose article 104 comprises at least a first film 105 and second film 106 wherein the first film 105 and second film 106 are sealed together forming a seal area 107 wherein said seal area 107 runs around the periphery of the pouch defining a first two dimensional cross-sectional plane 108. The unit dose article 104 comprises a first smallest cross-sectional axis 109 and a first largest cross sectional axis 110 wherein the first smallest 109 and first largest cross-sectional axis 110 cross one another through a geometrical centre point 111 of the first two dimensional cross-sectional plane 108. The internal compartment 103 of the container 101 comprises a second two-dimensional cross-sectional plane 112 parallel to the first two-dimensional cross-sectional plane 108. The internal compartment 103 comprises a second smallest cross-sectional axis 113 and a second largest cross sectional axis 114 wherein the second smallest 113 and second largest cross-sectional axis 114 cross one another through a geometrical centre point 115 of the second two dimensional cross-sectional plane 112. The ratio of the first largest cross-sectional dimension 110 to the second largest cross-sectional dimension 114 is from 1.2:1 to 1:1.8, preferably from 1:1.1 to 1:1.6, more preferably from 1:1.2 to 1:1.5 and the first smallest cross-sectional dimension 109 to the second smallest cross-sectional dimension 113 of the internal compartment 103 is from 1.2:1 to 1:1.8, preferably from 1:1.1 to 1:1.6, more preferably from 1:1.2 to 1:1.5.

Without wishing to be bound by theory, by reducing the amount of available space between neighbouring unit dose articles and between unit dose articles and the walls of the first compartment, the amount of free space available for moisture ingress is reduced so reducing the overall problem of moisture contamination of the unit dose articles. In addition, this has the added benefit of minimising wasted space and wasted package material providing environmental and cost savings.

By ‘flexible’ we herein mean that the water-soluble unit dose articles are not rigid, rather they are formed in a manner that allows the shape to deform upon application of a suitable external force, but return to substantially their original shape upon removing said external force. This deformation characteristic allows the unit dose article to ‘squash’ allowing it to fit into a space that is smaller than a particular dimension of the unit dose article when the unit dose article is at rest. For example, the side walls of the container may be placed at a distance smaller than the width of the unit dose article. However, when the unit dose article is placed between them, the width of the unit dose article decreases due to the pressure exerted by the side walls, but the height of the unit dose article may correspondingly increase to accommodate the reduced internal volume of the unit dose article caused by the reduced width.

By ‘periphery’ we herein mean the outer perimeter of the unit dose article as a whole. It does not mean for example the outer perimeter an individual compartment of the unit dose article wherein the unit dose article has more than one compartment.

The unit dose article may comprise a flange. Said flange is comprised of excess sealed film material that protrudes beyond the edge of the unit dose article and provides increased surface area for seal of the first and second films. It is located at the seal area. Since the flange is also made of the same flexible film material, it may also ‘squash’ or deform to accommodate the unit dose article in the container.

The periphery of the unit dose article may exclude the flange. If the periphery of the unit dose article excludes the flange, the ratio of the first largest cross-sectional dimension to the second largest cross-sectional dimension is preferably from 0.99:1 to 0.99:1.8 and the first smallest cross-sectional dimension to the second smallest cross-sectional dimension of the internal compartment is from 0.99:1 to 0.99:1.8.

The container may comprise at maximum 25 unit dose articles. Without wishing to be bound by theory, if too many unit dose articles are present, then there may be undue pressure exerted on some unit dose articles by the surrounding articles which may result in unwanted rupture of unit dose articles.

The first compartment and the second compartment are connected via an internal opening. The internal opening comprises a first blocking means between the first and second compartments. The removable blocking means may move from an open to a closed position and vice versa. The operation of the removable blocking means is described in more detail below.

The internal opening is of sufficient size to allow the unit dose article to move from the first compartment to the second compartment when the removable blocking means is in an open position.

The container comprises an external opening. The blocking means has an upper surface and a lower surface wherein the upper surface faces the first compartment and the lower surface faces the second compartment. The external opening has a cross sectional area and the opening connects to the second compartment. The centre point of the cross-sectional area of the external opening is located at an angle of between 45° and 135°, preferably between 75° and 105°, most preferably 90° relative to the centre point of the lower surface of the blocking means.

The blocking means may be made from any suitable material. They made be made from the same or different materials. The blocking means may be made from metallic materials, Aluminium, plastic materials, cardboard materials, laminates, cellulose pulp materials or a mixture thereof. The blocking means may be made from a plastic material, preferably a polyolefin material. The blocking means may be made from polypropylene, polystyrene, polyethylene, polyethylene terephthalate, PVC or a mixture thereof or more durable engineering plastics like Acrylonitrile Butadiene Styrene (ABS), Polycarbonates, Polyamides and the like The material used to make the blocking means may comprise other ingredients, such as colorants, preservatives, plasticisers, UV stabilizers, Oxygen, perfume and moisture barriers recycled materials and the like.

Those skilled in the art will recognise suitable materials needed to achieve this.

The blocking means may be made used any suitable process. Suitable processes include but are not limited to thermoforming, injection molding and stretch molding.

The blocking means may be opaque, transparent, translucent or a mixture thereof. Preferably, the blocking means are opaque.

Preferably, the container comprises an actuation means to move the blocking means between a closed and open position and back to a closed position.

Without wishing to be bound by theory, upon activation of the actuation means, the blocking means opens to allow a unit dose article to move from the first to the second compartments. Upon release of the actuation means, the blocking means closes again housing a single unit dose article in the second compartment, but not allowing any further unit dose articles to exit the first compartment. The container is then tilted to allow the unit dose article to travel via gravity from the second compartment and through the external opening. This means that only one unit dose article at a time is allowed to exit the container upon actuation. Since only one unit dose article exits at a time, the consumer does not need to touch it in order to retrieve it as a single article and by virtue the consumer does not need to touch any neighbouring articles. Furthermore, the operation of the blocking means has the added benefit of separating neighbouring unit dose articles that are stuck together. Since only one unit dose article fits in the second compartment, the ‘stuck unit dose article will be protruding into the first compartment. As the re-closable means closes, it will move between the two stuck unit dose articles and separate them.

Those skilled in the art would recognise suitable actuation means. The actuation means may be mechanical, electronic or a mixture thereof, preferably mechanical means. Those skilled in the art would recognise suitable mechanical means. Preferably, the actuation means is a manually operated mechanical means. By this we herein mean the consumer uses their hand to operate the actuation means, for example, pressing a button. The mechanical means may be selected from spring mechanisms, twist mechanisms, push or pull mechanisms, turn mechanisms, gear wheels and mixtures thereof. The mechanical means may be a manually operated mechanical means.

Preferably the actuation means is a child deterrent actuation means. By this we mean an actuation means that children find difficult or impossible to operate but which can be operated by adults. Those skilled in the art would recognise suitable child deterrent actuation means.

The external opening may comprises a child deterrent closure. This would be in addition to the second re-closable means. The child deterrent closure would need to be opened prior to operation of the actuation means to effect release of the unit dose article. In other words, if the child deterrent closure is closed, even if the second re-closable means is open, then the unit dose article would not exit the container. Those skilled in the art would recognise suitable child deterrent closures.

The container may comprise a means to allow it to be temporarily secured to a surface. For example it may comprise a releasable pressure means such as a ‘vacuum suction cup’, an adhesive, a hanging element or a mixture thereof. Without wishing to be bound by theory such a means would hinder children in obtaining the container. Also, it would help secure the container to a position for later easy retrieval.

### Flexible Water-Soluble Unit Dose Article

A water-soluble unit dose article is generally in the form of a pouch. It comprises a unitary dose of a composition as a volume sufficient to provide a benefit in an end application.

The water-soluble unit dose article comprises at least one water-soluble film shaped such that the unit-dose article comprises at least one internal compartment surrounded by the water-soluble film. The at least one compartment comprises a cleaning composition. The water-soluble film is sealed such that the cleaning composition does not leak out of the compartment during storage. However, upon addition of the water-soluble unit dose article to water, the water-soluble film dissolves and releases the contents of the internal compartment into the wash liquor.

The compartment should be understood as meaning a closed internal space within the unit dose article, which holds the composition. Preferably, the unit dose article comprises a water-soluble film. The unit dose article is manufactured such that the water-soluble film completely surrounds the composition and in doing so defines the compartment in which the composition resides. The unit dose article may comprise two films. A first film may be shaped to comprise an open compartment into which the composition is added. A second film is then laid over the first film in such an orientation as to close the opening of the compartment. The first and second films are then sealed together along a seal region. The film is described in more detail below.

The unit dose article may comprise more than one compartment, even at least two compartments, or even at least three compartments, or even at least four compartments, or even at least five compartments. The compartments may be arranged in superposed orientation, i.e. one positioned on top of the other. Alternatively, the compartments may be positioned in a side-by-side orientation, i.e. one orientated next to the other. The compartments may even be orientated in a ‘tyre and rim’ arrangement, i.e. a first compartment is positioned next to a second compartment, but the first compartment at least partially surrounds the second compartment, but does not completely enclose the second compartment. Alternatively one compartment may be completely enclosed within another compartment.

Wherein the unit dose article comprises at least two compartments, one of the compartments may be smaller than the other compartment. Wherein the unit dose article comprises at least three compartments, two of the compartments may be smaller than the third compartment, and preferably the smaller compartments are superposed on the larger compartment. The superposed compartments preferably are orientated side-by-side.

In a multi-compartment orientation, the cleaning composition may be comprised in at least one of the compartments. It may for example be comprised in just one compartment, or may be comprised in two compartments, or even in three compartments.

The cleaning composition may be a laundry detergent composition, an automatic dishwashing composition, a hard surface cleaning composition or a combination thereof. The cleaning composition may comprise a solid, a liquid or a mixture thereof. The term liquid includes a gel, a solution, a dispersion, a paste or a mixture thereof.

The unit dose article may comprise a flange. Said flange is comprised of excess sealed film material that protrudes beyond the edge of the unit dose article and provides increased surface area for seal of the first and second films.

The unit dose article has a height, a width and a length. The maximum of any of these dimensions is meant to mean the greatest distance between two points on opposite sides of the unit dose article. In other words, the unit dose article may not have straight sides and so may have variable lengths, widths and heights depending on where the measurement is taken. Therefore, the maximum should be measured at any two points that are the furthest apart from each other.

The maximum length may be between 2 cm and 5 cm, or even between 2 cm and 4 cm, or even between 2 cm and 3 cm. The maximum length maybe greater than 2 cm and less than 6 cm

The maximum width may be between 2 cm and 5 cm. The maximum width maybe greater than 3 cm and less than 6 cm.

The maximum height may be between 2 cm and 5 cm. The maximum height maybe greater than 2 cm and less than 4 cm.

These lengths may be in the presence or absence of the flange.

Preferably, the length: height ratio is from 3:1 to 1:1; or the width: height ratio is from 3:1 to 1:1, or even 2.5:1 to 1:1; or the ratio of length to height is from 3:1 to 1:1 and the ratio of width to height is from 3:1 to 1:1, or even 2.5:1 to 1:1, or a combination thereof. These ratios may be in the presence of absence of a flange.

Each individual unit dose article may have a weight of between 10 g and 40 g, or even between 15 g and 35 g.

One or more sides of the unit dose article may have a radius of curvature. In other words, the unit dose article preferably does not comprise substantially straight sides or right angled corners. Without wishing to be bound by theory, this is preferred as it reduces the available surface area of unit dose articles to contact one another and the walls of the container. Preferably the contacting sides between the side by side positioned unit dose articles have a radius of curvature.

The film of the present invention is soluble or dispersible in water. Prior to be being formed into a unit dose article, the water-soluble film preferably has a thickness of from 20 to 150 micron, preferably 35 to 125 micron, even more preferably 50 to 110 micron, most preferably about 76 micron.

Preferably, the film has a water-solubility of at least 50%, preferably at least 75% or even at least 95%, as measured by the method set out here after using a glass-filter with a maximum pore size of 20 microns:

50 grams±0.1 gram of film material is added in a pre-weighed 400 ml beaker and 245 ml±1 ml of distilled water is added. This is stirred vigorously on a magnetic stirrer, Labline model No. 1250 or equivalent and 5 cm magnetic stirrer, set at 600 rpm, for 30 minutes at 24° C. Then, the mixture is filtered through a folded qualitative sintered-glass filter with a pore size as defined above (max. 20 micron). The water is dried off from the collected filtrate by any conventional method, and the weight of the remaining material is determined (which is the dissolved or dispersed fraction). Then, the percentage solubility or dispersability can be calculated.

Preferred film materials are preferably polymeric materials. The film material can, for example, be obtained by casting, blow-molding, extrusion or blown extrusion of the polymeric material, as known in the art.

Preferred polymers, copolymers or derivatives thereof suitable for use as pouch material are selected from polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum. Preferably, the level of polymer in the pouch material, for example a PVA polymer, is at least 60%. The polymer can have any weight average molecular weight, preferably from about 1000 to 1,000,000, more preferably from about 10,000 to 300,000 yet more preferably from about 20,000 to 150,000.

Mixtures of polymers can also be used as the pouch material.

Preferred films exhibit good dissolution in cold water, meaning unheated distilled water. Preferably such films exhibit good dissolution at temperatures of 24° C., even more preferably at 10° C. By good dissolution it is meant that the film exhibits water-solubility of at least 50%, preferably at least 75% or even at least 95%, as measured by the method set out here after using a glass-filter with a maximum pore size of 20 microns, described above.

Preferred films are those supplied by Monosol under the trade references M8630, M8900, M8779, M8310, films.

Of the total PVA resin content in the film described herein, the PVA resin can comprise about 30 to about 85 wt % of the first PVA polymer, or about 45 to about 55 wt % of the first PVA polymer. For example, the PVA resin can contain about 50 w. % of each PVA polymer, wherein the viscosity of the first PVA polymer is about 13 cP and the viscosity of the second PVA polymer is about 23 cP.

The film may be opaque, transparent or translucent. The film may comprise a printed area. The printed area may cover between 10 and 80% of the surface of the film; or between 10 and 80% of the surface of the film that is in contact with the internal space of the compartment; or between 10 and 80% of the surface of the film and between 10 and 80% of the surface of the compartment.

The area of print may cover an uninterrupted portion of the film or it may cover parts thereof, i.e. comprise smaller areas of print, the sum of which represents between 10 and 80% of the surface of the film or the surface of the film in contact with the internal space of the compartment or both.

The area of print may comprise inks, pigments, dyes, blueing agents or mixtures thereof. The area of print may be opaque, translucent or transparent.

The area of print may comprise a single colour or maybe comprise multiple colours, even three colours. The area of print may comprise white, black, blue, red colours, or a mixture thereof. The print may be present as a layer on the surface of the film or may at least partially penetrate into the film. The film will comprise a first side and a second side. The area of print may be present on either side of the film, or be present on both sides of the film. Alternatively, the area of print may be at least partially comprised within the film itself.

The area of print may comprise an ink, wherein the ink comprises a pigment. The ink for printing onto the film has preferably a desired dispersion grade in water. The ink may be of any color including white, red, and black. The ink may be a water-based ink comprising from 10% to 80% or from 20% to 60% or from 25% to 45% per weight of water. The ink may comprise from 20% to 90% or from 40% to 80% or from 50% to 75% per weight of solid.

The ink may have a viscosity measured at 20° C. with a shear rate of 1000s⁻¹ between 1 and 600 cPs or between 50 and 350 cPs or between 100 and 300 cPs or between 150 and 250 cPs. The measurement may be obtained with a cone-plate geometry on a TA instruments AR-550 Rheometer.

The area of print may be achieved using standard techniques, such as flexographic printing or inkjet printing. Preferably, the area of print is achieved via flexographic printing, in which a film is printed, then molded into the shape of an open compartment. This compartment is then filled with a detergent composition and a second film placed over the compartment and sealed to the first film. The area of print may be on either or both sides of the film.

Alternatively, an ink or pigment may be added during the manufacture of the film such that all or at least part of the film is coloured.

The film may comprise an aversive agent, for example a bittering agent. Suitable bittering agents include, but are not limited to, naringin, sucrose octaacetate, quinine hydrochloride, denatonium benzoate, or mixtures thereof. Any suitable level of aversive agent may be used in the film. Suitable levels include, but are not limited to, 1 to 5000 ppm, or even 100 to 2500 ppm, or even 250 to 2000 rpm.

The unit dose article may be flowed wrapped. Flow wrapped unit dose articles comprise an outer water insoluble or water-soluble film. The flow wrapped unit dose articles maybe joined together by the external flow wrap film and wherein the flow wrap film comprises an area of weakness between adjacent unit dose articles to allow them to be separated. An example of an area of weakness is a perforated line.

### Method of Use

The present invention is to a process for releasing a unit dose article from a packaged product according to the present invention, comprising the steps of;
a. obtaining the container wherein the blocking means is in a closed position and wherein the container comprises at least two unit dose articles;
b. moving the blocking means to an open position and allowing a single unit dose article to move to the second compartment;
c. closing the blocking means;
d. tilting the container to allow a single unit dose article to be ejected from the external opening.

Preferably, the container comprises an actuation means as described herein and step b is achieved by a user activating the actuation means, and step c is achieved by a user deactivating the actuation means.

Without wishing to be bound by theory, upon activation of the actuation means, the blocking means opens to allow a unit dose article to move from the first to the second compartments. Upon release of the actuation means, the blocking means closes again housing a single unit dose article in the second compartment, but not allowing any further unit dose articles to exit the first compartment. The container is then tilted to allow the unit dose article to travel via gravity from the second compartment and through the external opening. This means that only one unit dose article at a time is allowed to exit the container upon actuation. Since only one unit dose article exits at a time, the consumer does not need to touch it in order to retrieve it as a single article and by virtue the consumer does not need to touch any neighbouring articles. Furthermore, the operation of the blocking means has the added benefit of separating neighbouring unit dose articles that are stuck together. Since only one unit dose article fits in the second compartment, the ‘stuck unit dose article will be protruding into the first compartment. As the re-closable means closes, it will move between the two stuck unit dose articles and separate them.

The unit dose article may move from the first compartment to the second compartment via any suitable means. Preferably, the unit dose article moves from the first compartment to the second compartment due to the force of gravity. The movement of the unit dose article may be assisted by an appropriate mechanical means contained within the container. Those skilled in the art would know suitable mechanical means to achieve this. Movement of the unit dose article from the first compartment to the second compartment may be assisted by the consumer shaking or tilting the container. Movement of the unit dose article from the first compartment to the second compartment may be assisted by a mixture of the above.

In addition, if the container is held within the drum of washing machine, a unit dose article can be ejected directly into said drum without the consumer having to touch the unit dose article.

### EXAMPLES

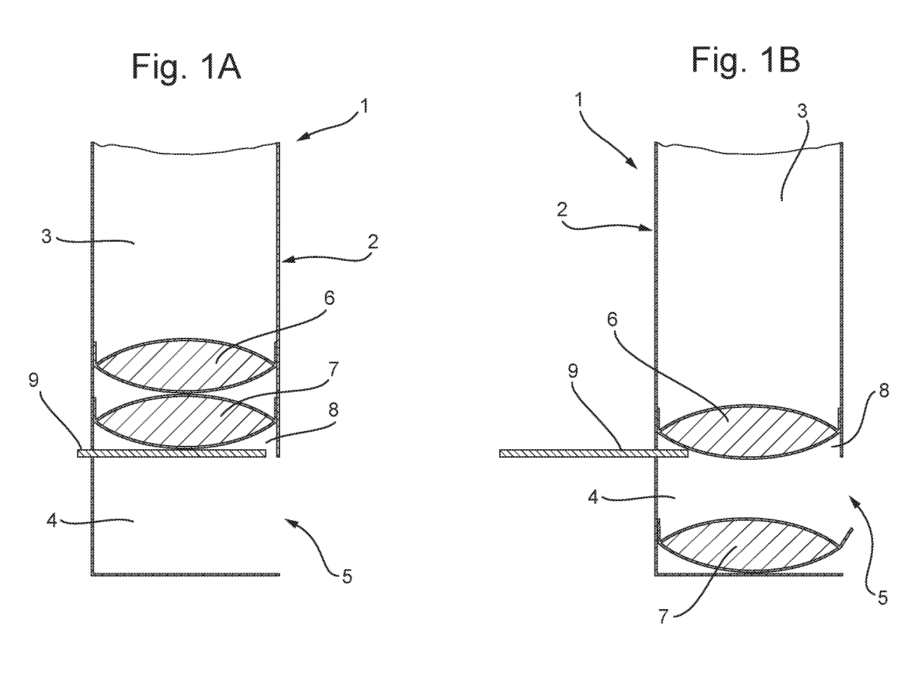

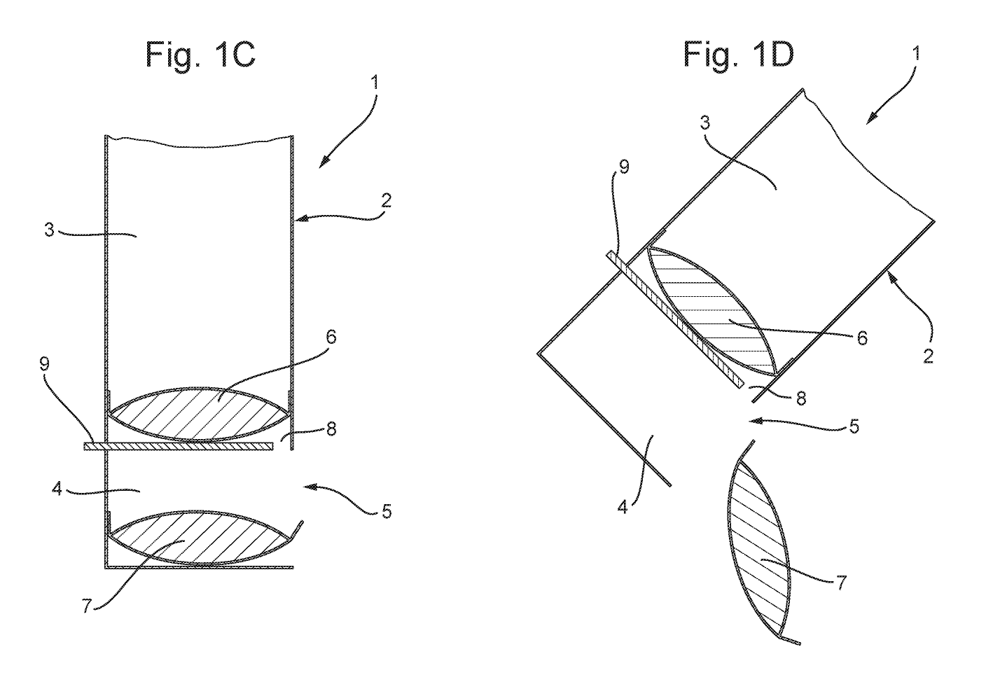

FIG. 1A discloses a packaged product (1) comprising a container (2), wherein the container (2) comprises a first compartment (3), a second compartment (4) and an external opening (5), wherein the container (2) comprises at least two flexible water-soluble unit dose articles (6 and 7), wherein the first compartment (3) and the second compartment (4) are connected via an internal opening (8), wherein the internal opening (8) comprises a removable blocking means (9) between the first (3) and second compartments (4), wherein the blocking means (9) is sufficient to prevent a water-soluble unit dose article (6) from passing through the internal opening (8) and wherein the external opening (5) connects to the second compartment (4) and is located at an angle of between 75° and 105° relative to the second compartment (4). The removeable blocking means (9) is in the closed position.

FIG. 1B shows the packaged product (1) of FIG. 1A wherein the removable blocking means (9) is open. As such the water-soluble unit dose article (7) has moved from the first compartment (3) through the internal opening (8) and into the second compartment (4).

FIG. 1C shows the packaged product (1) of FIGS. 1A and 1B, wherein the removable blocking means (9) has been returned to the closed position so preventing the water-soluble unit dose article (6) from passing from the first compartment (3) to the second compartment (4).

FIG. 1D shows the packaged product (1) of FIGS. 1A, 1B and 1C, wherein the container (2) has been tilted so that the unit dose article (7) can exit through the external opening (5), however the second unit dose article (6) remains in the first compartment (3).

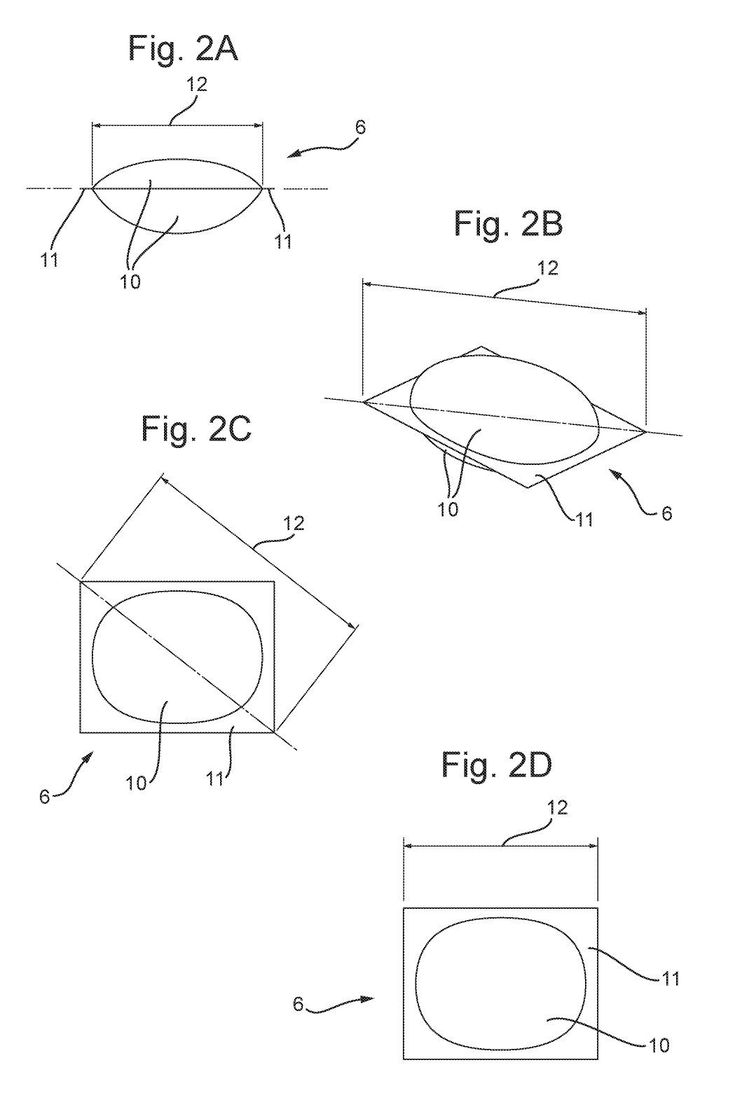

FIG. 2A discloses a side profile of a unit dose article (6) comprising a radius of curvature (10), and flanges (11). It also discloses the longest cross sectional dimension of the unit dose article (12).

FIG. 2B discloses a three dimensional representation of a unit dose article (6) highlighting the longest cross sectional dimension (12).

FIGS. 2C and 2D disclose top profile representation of unit dose articles (6) highlighting the longest cross sectional dimension (12).

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

“Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.”

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A packaged product comprising a container, wherein the container comprises a first compartment, a second compartment and an external opening, wherein the container comprises at least two flexible water-soluble unit dose articles, wherein the first compartment and the second compartment are connected via an internal opening, wherein the internal opening comprises a removable blocking means between the first and second compartments, wherein the blocking means is sufficient to prevent a water-soluble unit dose article from passing through the internal opening and wherein the blocking means has an upper surface and a lower surface wherein the upper surface faces the first compartment and the lower surface faces the second compartment; and
wherein the external opening has a cross sectional area and wherein the opening connects to the second compartment and wherein the centre point of the cross-sectional area of the external opening is located at an angle of between 45° and 135°, preferably between 75° and 105°, most preferably 90° relative to the centre point of the lower surface of the blocking means.

2. The container according to claim 1, wherein the container comprises an actuation means to move the blocking means when actuated by a user.

3. The container according to claim 2, wherein the actuation means is a manual actuation means, preferably a child deterrent actuation means.

4. The packaged product according to claim 1, wherein the package comprises at most 25 articles.

5. The packaged product according to claim 1, wherein the internal compartment of the container has a circular, square, rectangular, triangular, oval shape or a mixture thereof.

6. The packaged product according to claim 1 wherein the second compartment has a size sufficient to fit only one unit dose article.

7. The packaged product according to claim 1, wherein the container and/or blocking means are opaque, transparent or translucent, preferably the container and/or blocking means are opaque.

8. The packaged product according to claim 1, wherein the unit dose article has a height, a width and a length, wherein,
the maximum length is between 2 cm and 5 cm, or even between 2 cm and 4 cm, or even between 2 cm and 3 cm;
the maximum width is between 2 cm and 5 cm;
the maximum height may be between 2 cm and 5 cm.

9. The packaged product according to claim 1, wherein each individual unit dose article has a weight of between 10 and 40 g, preferably between 15 and 35 g.

10. The packaged product according to claim 1, wherein one or more sides of the unit dose article, preferably the contacting sides between side to side arranged unit dose articles, have a radius of curvature.

11. The packaged product according claim 1, wherein the unit dose article comprises a water-soluble film defining at least one internal compartment and a cleaning composition contained within said compartment, preferably wherein the cleaning composition is a liquid.

12. The packaged product according to claim 11, wherein the unit dose article comprises at least two, or even at least three, or even at least four, or even at least five compartments.

13. The packaged product according to claim 1, wherein the composition is a laundry detergent composition, an automatic dishwashing composition, a hard surface cleaning composition or a combination thereof.

14. A process for releasing a unit dose article from a packaged product according to any preceding means, comprising the steps of;
a. obtaining the container wherein the blocking means is in a closed position and wherein the container comprises at least two unit dose articles;
b. moving the blocking means to an open position and allowing a single unit dose article to move to the second compartment;
c. closing the blocking means;
d. tilting the container to allow a single unit dose article to be ejected from the external opening.

15. The process according to claim 14 wherein the container comprises an actuation means according to claim 3 and wherein step b is achieved by a user activating the actuation means, and step c is achieved by a user deactivating the actuation means.
